(19) United States
(12) Patent Application Publication
(10) Pub. No.: US 2010/0139573 A1
(43) Pub. Date: Jun. 10, 2010

(54) Pet carrier strapping system

(76) Inventors: Randy R. Wilson, Rio Linda, CA (US); Fred Cox, Sutter, CA (US)

Correspondence Address: LITMAN LAW OFFICES, LTD., POST OFFICE BOX 41200, SOUTH STATION, ARLINGTON, VA, 22204, US

(21) Appl. No.: 12/654,067

(22) Filed: Dec. 9, 2009

Related U.S. Application Data
(60) Provisional application No. 61/193,614, filed on Dec. 10, 2008.

(51) Int. Cl. A01K 1/00

(52) U.S. Cl. 119/496

(57) ABSTRACT

The pet carrier includes a pair of lateral straps attached or attachable to lateral ends of the pet transport device to form loops adapted for extending the vehicle seat belt therethrough to secure the frame of the device to the vehicle seat. The strapping system also has a third strap having one end forming a loop on the exterior of the pet carrier or transport device, and an opposite end extending into the interior of the carrier, pet seat, or other transport device and terminating in a snap hook or the like for attachment to a pet collar. The vehicle seat belt also extends through the third strap's loop so that both the carrier and a pet tether are restrained by the vehicle's seatbelt.

### CROSS-REFERENCE TO RELATED APPLICATION

This application claims the benefit of U.S. Provisional Patent Application Ser. No. 61/193,614, filed Dec. 10, 2008.

### BACKGROUND OF THE INVENTION

1. Field of the Invention

The present invention relates to devices for transporting pets in a motor vehicle, and more specifically to a pet carrier strapping system that can be used to secure any type of pet carrier, pet seat, or other container or device, whether a fully enclosed or partially open container or carrier, to an automobile seat when transporting the pet by motor vehicle.

2. Description of the Related Art

There has long been recognized a need to provide various types of devices associated with the carrying and transport of pets. Many devices have been developed for this purpose. Traditional devices may completely enclose the pet in a carrier providing only limited visibility for the pet during transport, or may merely boost the pet's position above a car seat thus providing greater visibility and freedom. Additionally, most pet carriers are used by the pets only for transport, which may occur infrequently. For many pets, the forcible placement into a foreign cage of synthetic, unfamiliar material creates additional, unnecessary stress. This is accompanied by a subsequent stressful ride in a vehicle and/or a visit to a veterinarian. If the veterinarian is the destination of the transport, there is added difficulty with the need to forcibly remove the pet from the carrier prior to examination. If the pet carrier could be used to transport the animal from the car, the stress to the animal of forcibly removing it from the pet carrier in the car around street traffic, and the like could be avoided.

Most importantly, however, is the safety of the pet support, be it an enclosure, booster seat, or other type of carrier intended to be used in an automotive vehicle. Whatever device is used should be capable of being securely fastened in the vehicle, using the vehicle's existing passenger restraint system.

Thus, a pet carrier strapping system solving the aforementioned problems is desired.

### SUMMARY OF THE INVENTION

The pet carrier strapping system is a set of straps attached to, or adapted for attachment to, and type of device for transporting a pet, including fully enclosed pet carriers, open pet seats, and the like in order to secure the transport device to the existing seatbelt restraining system of a motor vehicle. The system includes a pair of lateral straps attached or attachable to lateral ends of the pet transport device to form loops adapted for extending the vehicle seat belt therethrough to secure the frame of the device to the vehicle seat. The strapping system also has a third strap having one end forming a loop on the exterior of the pet carrier or transport device, and an opposite end extending into the interior of the carrier, pet seat, or other transport device and terminating in a snap hook or the like for attachment to a pet collar. The vehicle seat belt also extends through the third strap's loop so that both the carrier and a pet tether are restrained by the vehicle's seatbelt.

In the present application, the pet carrier strapping system will be illustrated in conjunction with a pet carrier having a collapsible enclosure that zips together to make a carrier and cover for an automobile pet seat. Such a pet carrier may have a removable bottom that can be zipped onto the rest of the unit to make it a standalone pet carrier without the pet seat An exemplary carrier may have side vents that can be opened for air flow or closed to keep the pet warm. A zip-open door or flap may be provided to allow the pet to easily be placed in or removed from the carrier. A handle or strap may be provided on the carrier to allow the carrier to be carried with or without a pet seat. Although the pet carrier strapping system is illustrated in conjunction with the above-described pet carrier, it should be understood that the pet carrier strapping system may be used with any pet transport device suitable for transporting the pet by vehicle.

These and other features of the present invention will become readily apparent upon further review of the following specification and drawings.

### BRIEF DESCRIPTION OF THE DRAWINGS

FIG. 1 is an environmental, perspective view of a pet carrier having a pet carrier strapping system according to the present invention as seen from an end of the carrier.

FIG. 2 is an environmental perspective view of the pet carrier of FIG. 1 as seen from the front.

FIG. 3 is an environmental, perspective view of the pet carrier of FIG. 1 used in combination with a pet seat.

FIG. 4 is an exploded, perspective view of the pet carrier of FIG. 3.

FIG. 5 is an environmental perspective view of the pet carrier of FIG. 1 as seen from the rear, showing a seat belt extending through the straps.

FIG. 6 is a partial perspective view of the pet carrier of FIG. 1, shown with the cover open.

FIG. 7 is a top view of the upper base portion of the pet carrier of FIG. 1, showing a drawstring for adjustment of the upper base portion.

Similar reference characters denote corresponding features consistently throughout the attached drawings.

### DETAILED DESCRIPTION OF THE PREFERRED EMBODIMENTS

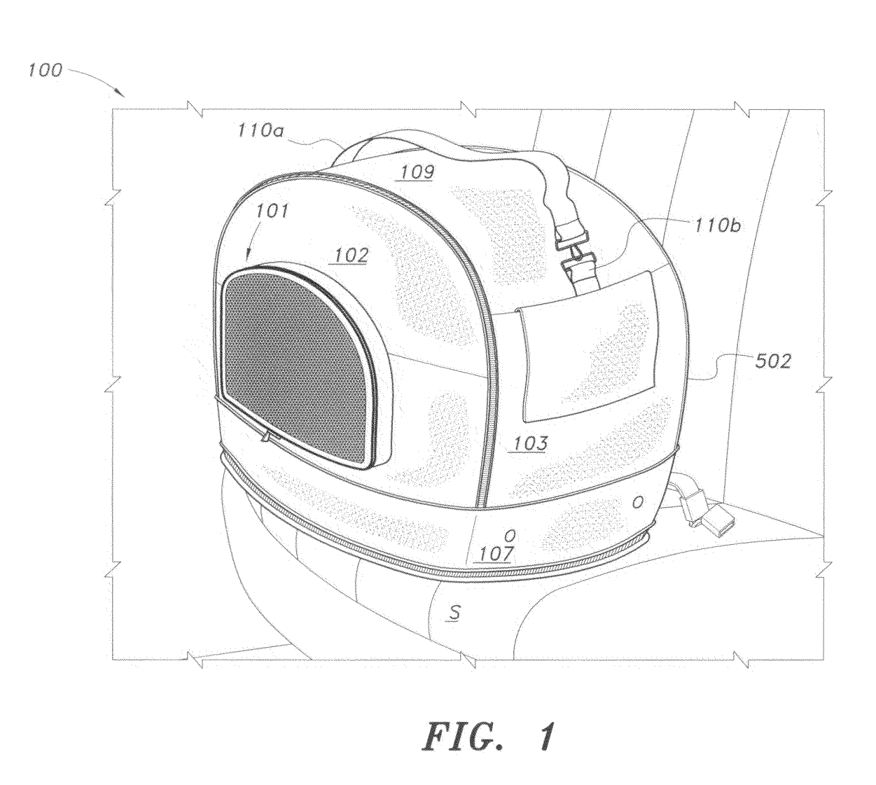

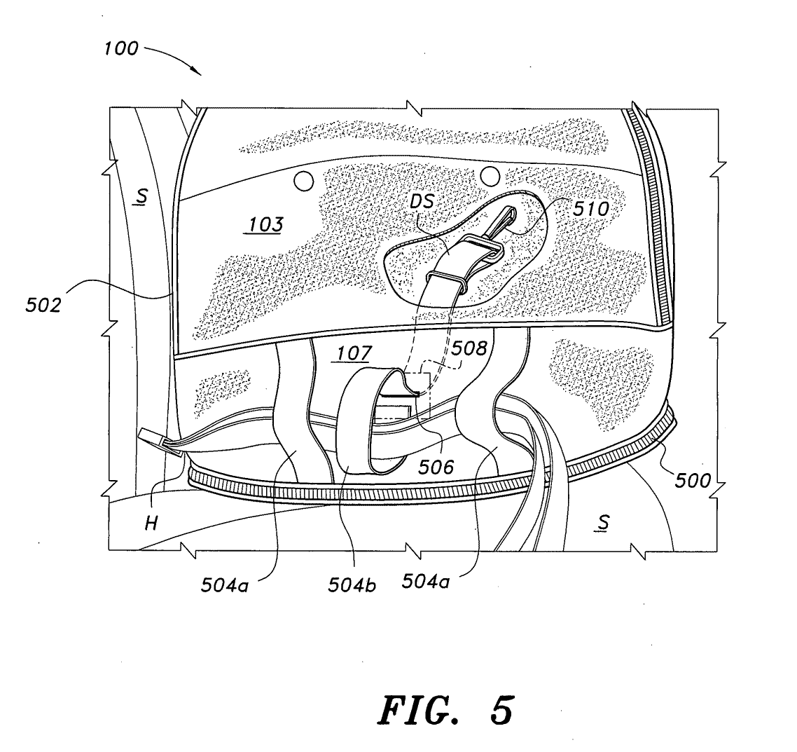

Referring to FIGS. 1 and 5, a pet carrier 100 formed from a collapsible enclosure may include a pet carrier strapping system comprising multiple stationary straps 504a and slidable strap 504b. The straps 504a, 504b may be made from nylon webbing or the like. The enclosure can be formed by a front panel 102, two opposing lateral side panels 103, a top panel 109, a rear panel 502 and a base 107 extending around the periphery of the lower portion of the enclosure. Lateral panels 103 and top panel 109 may be formed from a single cut of fabric or other suitably flexible material in which the top panel 109 extends into the lateral panels 103. Alternatively, the top panel 109 may be sewn, bonded, or otherwise attached to the lateral panels 103 at their top peripheral edges. Front panel 102 and rear panel 502 are joined, respectively, to front and rear edges of the lateral panels 103 and top panel 109, thereby completing the enclosure 100.

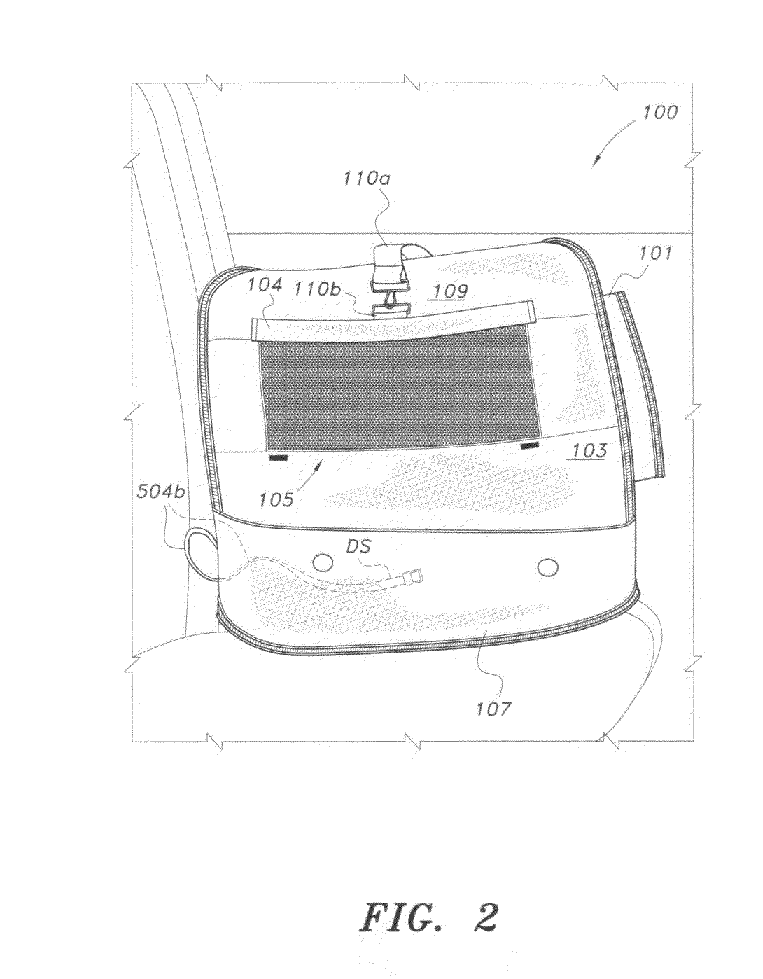

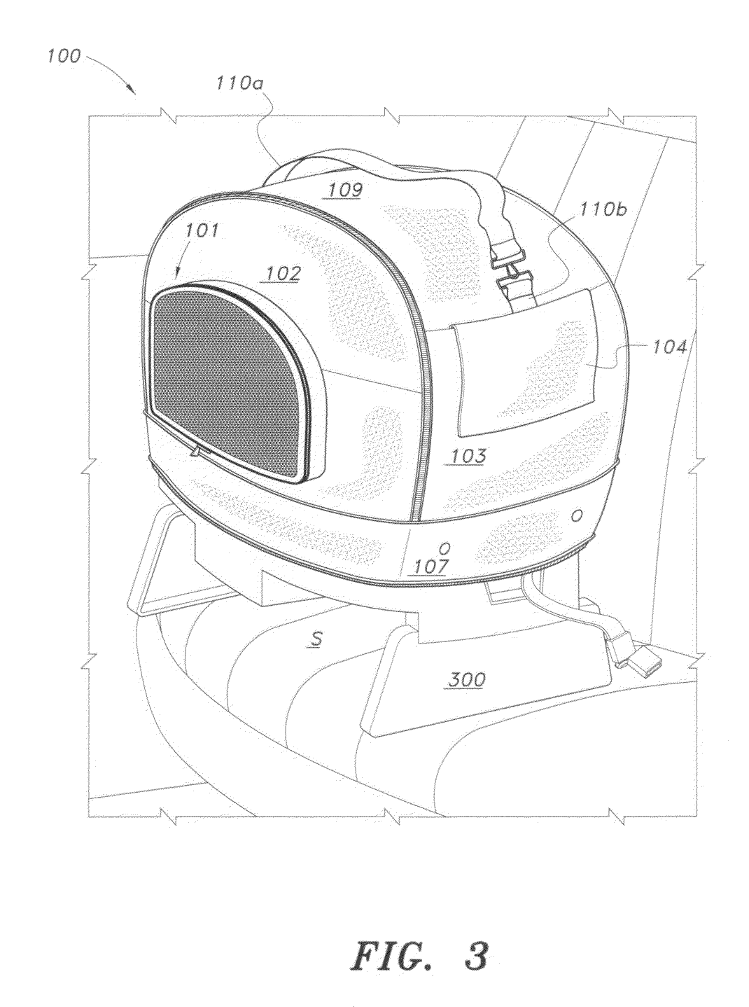

As shown in FIG. 3, the device zips together and has the capability to make a cover and carrier for an automobile pet seat 300. As shown in FIGS. 2-5, the pet carrier 100 has a bottom panel 500 that can be zipped onto the base 107 of the unit to make it a standalone pet carrier that can be placed directly on a car seat S, or removed from the base 107 so that the pet seat 300 can extend through the base 107.

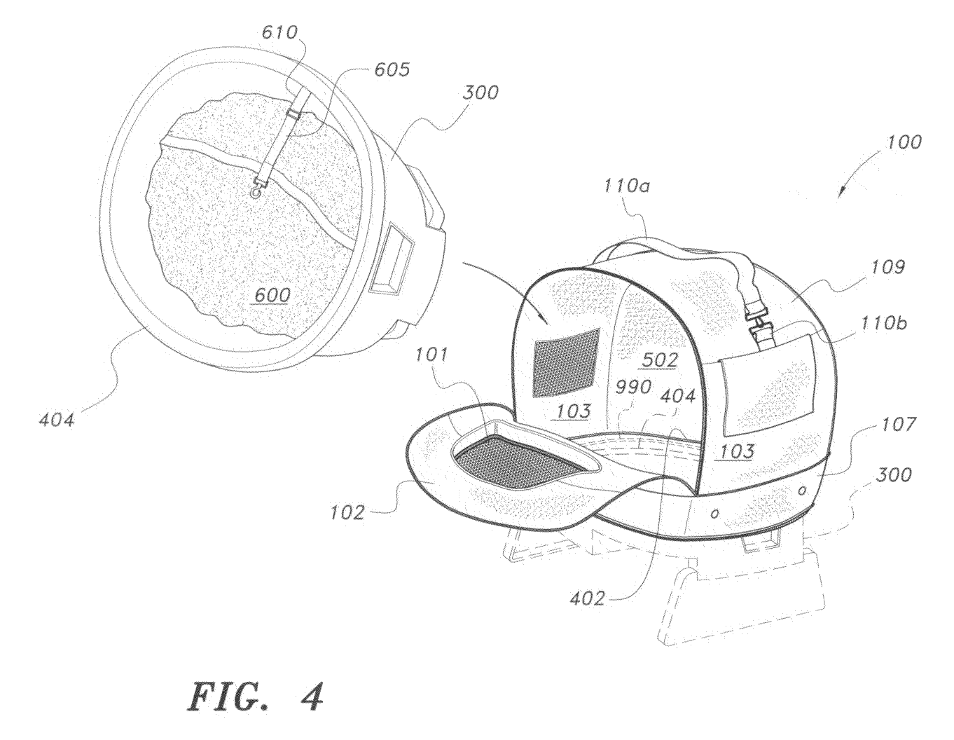

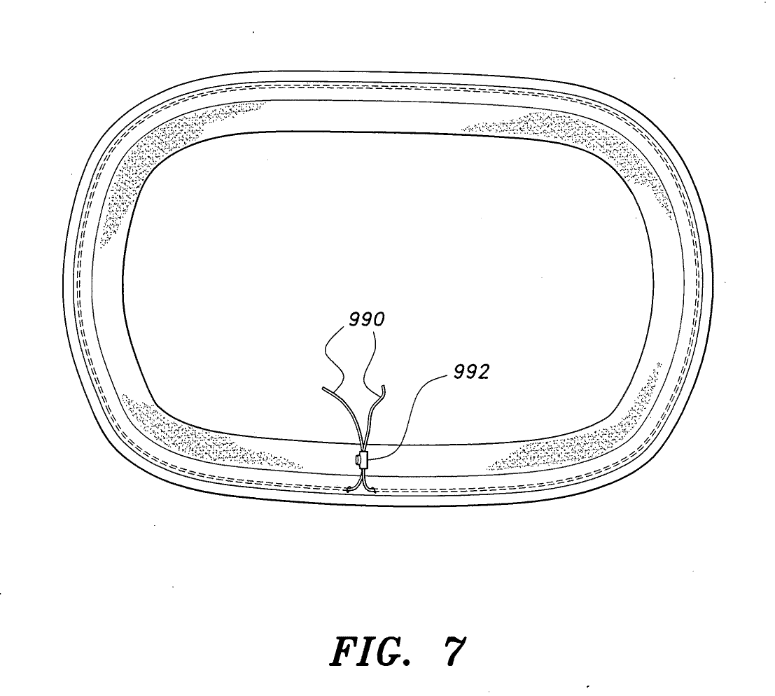

As shown in FIG. 4, the pet seat 300 preferably has a rim 404 forming a peripheral dimension that is greater than the remainder of the pet seat 300, and which is also greater than the peripheral dimension 402 of the bottom of the base 107, yet smaller in peripheral dimension that the remaining peripheral measurements of the carrier 100. The aforementioned described dimensions of pet seat 300 allow for the seat to be placed into the carrier 100 and wedged into the base 107 of the carrier 100. The pet seat 300 may have a pet-harnessing leash 605 secured to attachment web 610 for securing the pet to the pet seat 300. Additionally, the seat 300 may have a fluffy pillow or cushion 600 to aid in comforting the pet during transport. A drawstring 990 is disposed in a sheathe that extends about the periphery of the upper portion of base 107, defining peripheral dimension 402. As most clearly shown in FIGS. 4, 6 and 7, the drawstring 990, in combination with cinch locking button 992, can make an adjustment to peripheral dimension 402 in order to keep the carrier 100 from slipping off the plastic pet seat portion 300.

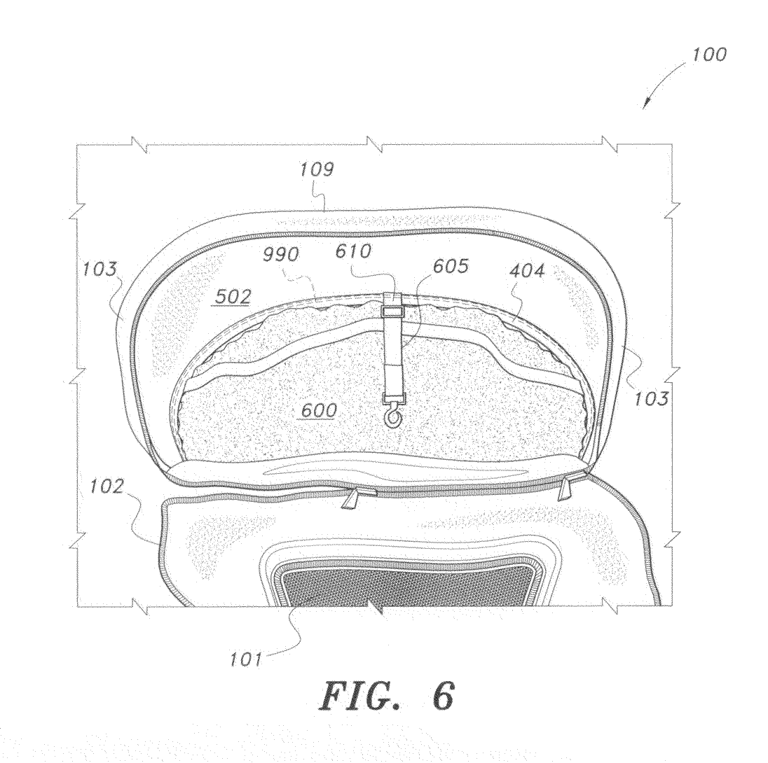

As shown in FIG. 2, the carrier 100 has side vents 105 removably coverable by a flap 104 that can be opened for air flow or closed to keep the pet warm. Dog strap DS, an extension of slidable center loop 504b seat belt strap is disposed inside the carrier and hooks to a dog's collar. As shown in FIG. 6, the front panel 102 has a zipper attachment flap along its periphery so that unzipping the front panel 102 exposes the interior portion of the carrier 100 to allow the pet to easily be placed in, or removed from, the carrier 100. A smaller zippered panel 101 is disposed on the front panel 102, and is movable when unzipped to provide additional headroom for a pet enclosed in the carrier 100. As shown in FIGS. 1, 3, and 4, a handle or strap 110a and strap hooks 110b attached to the carrier 100 are provided to allow the carrier 100 to be carried with or without pet seat 300.

As most clearly shown in FIG. 5, the vertically disposed straps 504a and 504b are attached to the base 107 or other panel of the carrier 100 in order to provide for removable attachment of the carrier 100 to a seatbelt harness H of car seat S for safe mobile transportation of the pet 100 while inside carrier 100. Middle strap 504b is sewn or otherwise attached to the exterior portion of the carrier base 107 on one end, the remaining end being slidably inserted through a slot 506 in the carrier base 107 so that the remaining end is always in the interior space of the carrier 100.

A rectangular shaped patch 508 is attached to the interior portion of carrier base 107 over the slot 506 for reinforcement of the base material around the slot 506, and has an opening through which the dog strap portion DS of middle strap 504b is disposed.

Extended portion DS, i.e., the interior portion of strap 504b, has at its end a spring-loaded or snap hook 510 or other attachment mechanism that removably attaches to the pet's collar. The pet carrier strapping system, having an arrangement of flexible straps, such as exemplary straps 504a and 504b extending into an interior dog strap DS, can be used in conjunction with a variety of vehicle borne pet support devices including, but not limited to, pet carriers, pet booster seats, and the like. The straps 504a, 504b may be fixed to the pet carrier, or may be removably attachable to the pet carrier, pet seat, or other pet transport device by extending the straps through vents or openings in the device, or by attaching one or both ends of the straps 504a, 504b to the device by releasable fasteners, such as clips, hooks, hook and loop fasteners, etc.

It is to be understood that the present invention is not limited to the embodiment described above, but encompasses any and all embodiments within the scope of the following claims.

We claim:

1. A pet carrier strapping system, comprising:
a pair of lateral straps adapted for attachment to a pet transport device, the straps forming loops adapted for extending a vehicle seat belt therethrough in order to secure the pet transport device to a vehicle seat; and
a pet tether strap having a first end forming a loop and a second end having a hook adapted for attachment to a pet collar, the strap being adapted for extending through the pet transport device, the loop being adapted for extending the seat belt therethrough in order to secure the pet tether to the vehicle seat.

2. The pet carrier strapping system according to claim 1, wherein the pet tether strap's first end is rigidly attached to the pet transport device, the pet tether strap having a central section extending through an opening in the pet transport device to form the loop.

3. The pet carrier strapping system according to claim 1, wherein the lateral straps are rigidly attachable to the pet transport device.

4. The pet carrier strapping system according to claim 1, wherein the lateral straps are removably attachable to the pet transport device.

5. A pet carrier strapping system, comprising
a pet carrier having an exterior portion and an interior portion;
a plurality of carrier straps attached to the exterior portion of the pet support to form flexible loops on the pet carrier exterior portion;
a pet tether strap having a first end attached to the pet carrier exterior portion proximate the carrier strap and a second end looped through the pet carrier into the interior portion, forming an additional loop outside the pet carrier, the loops being adapted for extending a vehicle seat belt therethrough in order to secure both the carrier and the pet tether to a vehicle seat; and
a hook attached to the second end of the pet tether strap, the hook being adapted for attachment to a pet collar.

6. The pet carrier strapping system according to claim 5, wherein the pet carrier comprises an enclosed container.

7. The pet carrier strapping system according to claim 5, wherein the pet carrier comprises a pet seat.

8. The pet carrier strapping system according to claim 5, the lateral straps and the pet tether strap are made of nylon webbing.

9. The pet carrier strapping system according to claim 5, wherein the hook comprises a snap hook.

10. A pet carrier, comprising:
a collapsible enclosure having a carrying handle, the enclosure being dimensioned and configured for placement on a passenger seat of a vehicle, the enclosure having a front panel, two opposing lateral side panels, a top panel, a rear panel, and a base extending around a periphery of a lower portion of the enclosure, the base having a generally smaller dimension than remaining peripheral dimensions of the collapsible enclosure, the top panel releasably joined to top peripheral edges of the front, side and rear panels to permit opening the enclosure, the base being removably attached to the collapsible enclosure;
a drawstring extending around the periphery of the lower portion of the enclosure;
a plurality of flexible looping members proximate each other, the flexible looping members being attached to an outside face of the collapsible enclosure;
an elongate flexible member having a first end attached to the collapsible enclosure proximate the flexible looping members and a second end extending through a narrow opening in the collapsible enclosure to form an additional exterior loop, the flexible looping members and the additional exterior loop being adapted for extending a seatbelt therethrough for securing the collapsible enclosure to a vehicle seat; and
a hook attached to the second end of the elongate flexible member, the hook being adapted for attachment to a pet collar.

11. The pet carrier according to claim 10, further comprising a pet seat having an outer peripheral dimension greater than the periphery of the base and smaller than the remaining peripheral dimension of the enclosure, so that when the base is detached from the lower periphery of the base of the collapsible enclosure, the pet seat is insertable through the opening and wedged into the lower periphery of the collapsible enclosure, the drawstring being tightened around the seat to secure the collapsible enclosure to the pet seat, thereby converting the pet seat into a covered pet carrier for transportation of the pet.
